(19) United States
(12) Patent Application Publication
(10) Pub. No.: US 2016/0146253 A1
(43) Pub. Date: May 26, 2016

(54) SEAL FOR STRUT BEARING

(71) Applicant: Schaeffler Technologies AG & Co. KG, Herzogenaurach (DE)

(72) Inventors: Robert Weiss, II, Sterling Heights, MI (US); Gerhard Meyer, Lehrberg (DE)

(73) Assignee: Schaeffler Technologies AG & Co. KG, Herzogenaurach (DE)

(21) Appl. No.: 14/923,822

(22) Filed: Oct. 27, 2015

Related U.S. Application Data
(60) Provisional application No. 62/082,198, filed on Nov. 20, 2014.

(51) Int. Cl. F16C 33/76; B60G 15/06; F16F 9/54

(52) U.S. Cl. CPC F16C 33/767; F16F 9/54; B60G 15/068

(57) ABSTRACT

An integrated seal for a strut bearing, the strut bearing including an upper housing superimposed onto a lower housing and a bearing assembled between the upper and lower housings. The integrated seal having at least a portion protruding above an upper radial surface of the upper housing arranged to contact and get compressed by a top mount of an associated strut assembly, forming a seal between the strut bearing and the top mount surfaces.

The present disclosure relates to strut bearings, in particular, a diaphragm seal for a strut bearing.

### BACKGROUND

MacPherson-style strut assemblies are well known in the automotive industry. Such assemblies typically comprise a strut which extends upward from the steering knuckle of the wheel and terminates in a top mount attached to the chassis of the vehicle. The strut includes a hydraulic cylinder or shock absorber and a spring for absorbing movement and bounce of the vehicle. The joint between the top mount and the strut contains a strut bearing. Typically, a strut bearing includes two relatively rotatable elements, for example an upper and lower housing made of plastic or metal, provided with a bearing arranged therebetween to facilitate rotation while at the same time permitting load transmission between the elements. The bearing can include rolling elements or a synthetic resin sliding bearing arrangement, both known in the art. The lower housing typically includes a spring seat, integrally formed, to support an upper end of the strut coil spring.

In order to ensure proper operation of the strut bearing, particularly of the rolling elements or sliding bearing, it is necessary to protect the bearing components from pollutants such as road dust and humidity. Several arrangements may prevent intrusion of dust and contaminants into the bearing, including a labyrinth or flinger type seal arrangement between the upper and lower housing, such as that shown in U.S. Pat. No. 6,948,728. In addition, it is possible for contamination to enter between the top mount and the strut bearing interface, entering the central areas of the bearing and causing damage over time.

### SUMMARY OF THE INVENTION

Certain terminology is used in the following description for convenience and descriptive purposes only, and is not intended to be limiting to the scope of the claims. The terminology includes the words specifically noted, derivatives thereof and words of similar import.

According to aspects illustrated herein, there is provided a strut assembly including: a top mount; a shock absorber having an axial abutment surface; a suspension strut bearing having a longitudinal axis in line with the shock absorber including: an upper housing having an upper and lower radial surface, a through hole for accommodating the shock absorber and a fixedly integrated seal around an entire circumference of the upper housing; a lower housing having an upper and a lower radial surface and a through hole for accommodating the shock absorber; the upper housing superimposed on the lower housing such that the through holes align; and, the integrated seal having a body extending from the lower radial surface of the upper housing toward the upper radial surface of the lower housing and an axially upward protruding portion extending from the seal body and above the upper radial surface of the upper housing toward the top mount; a coil spring arranged at least partially coaxially and surrounding the shock absorber and having a top and a bottom spring end, the bottom end supported on the shock absorber axial abutment surface and the top end supported on the lower radial surface of the lower housing; and, the top mount assembled onto the upper radial surface of the upper housing, compressing the axially upward protruding seal portion.

According to at least one example embodiment a strut bearing assembly is disclosed comprising: an upper housing having an upper and lower radial surface, a through hole arranged to accommodate a shock absorber and a fixedly integrated seal around an entire circumference of the upper housing; a lower housing having an upper and a lower radial surface and a through hole arranged to accommodate a shock absorber; the upper housing superimposed on the lower housing such that the through holes align; the integrated seal having a body extending from the lower radial surface of the upper housing toward the upper radial surface of the lower housing; and, an axially upward protruding portion extending from the seal body and above the upper radial surface of the upper housing arranged to contact a top mount.

### BRIEF DESCRIPTION OF DRAWINGS

The above mentioned and other features and advantages of the embodiments described herein, and the manner of attaining them, will become apparent and be better understood by reference to the following description of at least one example embodiment in conjunction with the accompanying drawings. A brief description of those drawings now follows.

FIG. 1 is a perspective view of a cylindrical coordinate system demonstrating spatial terminology used in the present application;

FIG. 2 is a cross sectional view of a strut assembly according to one example embodiment.

FIG. 3 is a perspective view of the strut bearing according to another example embodiment.

FIG. 4 is a top view of portion A of the strut bearing of FIG. 3.

FIG. 5 is a cross sectional view of the strut bearing taken along line A-A of FIG. 4.

### DETAILED DESCRIPTION

At the outset, it should be appreciated that like drawing numbers on different drawing views identify identical, or functionally similar, structural elements of the disclosure. It is to be understood that the disclosure as claimed is not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the present disclosure.

Unless defined otherwise, all technical and scientific terms used herein have the same meaning as commonly understood to one of ordinary skill in the art to which this disclosure belongs. It should be understood that any methods, devices or materials similar or equivalent to those described herein can be used in the practice or testing of the disclosure.

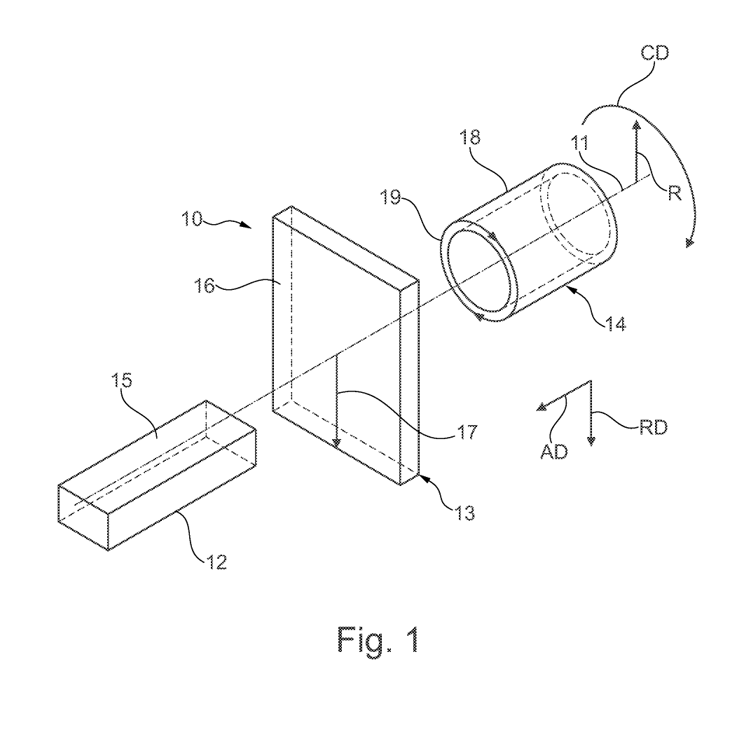

FIG. 1 is a perspective view of cylindrical coordinate system 10 demonstrating spatial terminology used in the present application. The present application is at least partially described within the context of a cylindrical coordinate system. System 10 includes longitudinal axis 11, used as the reference for the directional and spatial terms that follow. Axial direction AD is parallel to axis 11. Radial direction RD is orthogonal to axis 11. Circumferential direction CD is defined by an endpoint of radius R (orthogonal to axis 11) rotated about axis 11.

To clarify the spatial terminology, objects 12, 13, and 14 are used. An axial surface, such as surface 15 of object 12, is formed by a plane co-planar with axis 11. Axis 11 passes through planar surface 15; however any planar surface co-planar with axis 11 is an axial surface. A radial surface, such as surface 16 of object 13, is formed by a plane orthogonal to axis 11 and co-planar with a radius, for example, radius 17. Radius 17 passes through planar surface 16; however any planar surface co-planar with radius 17 is a radial surface. Surface 18 of object 14 forms a circumferential, or cylindrical, surface. For example, circumference 19 passes through surface 18. As a further example, axial movement is parallel to axis 11, radial movement is orthogonal to axis 11, and circumferential movement is parallel to circumference 19. Rotational movement is with respect to axis 11. The adverbs “axially,” “radially,” and “circumferentially” refer to orientations parallel to axis 11, radius 17, and circumference 19, respectively. For example, an axially disposed surface or edge extends in direction AD, a radially disposed surface or edge extends in direction R, and a circumferentially disposed surface or edge extends in direction CD.

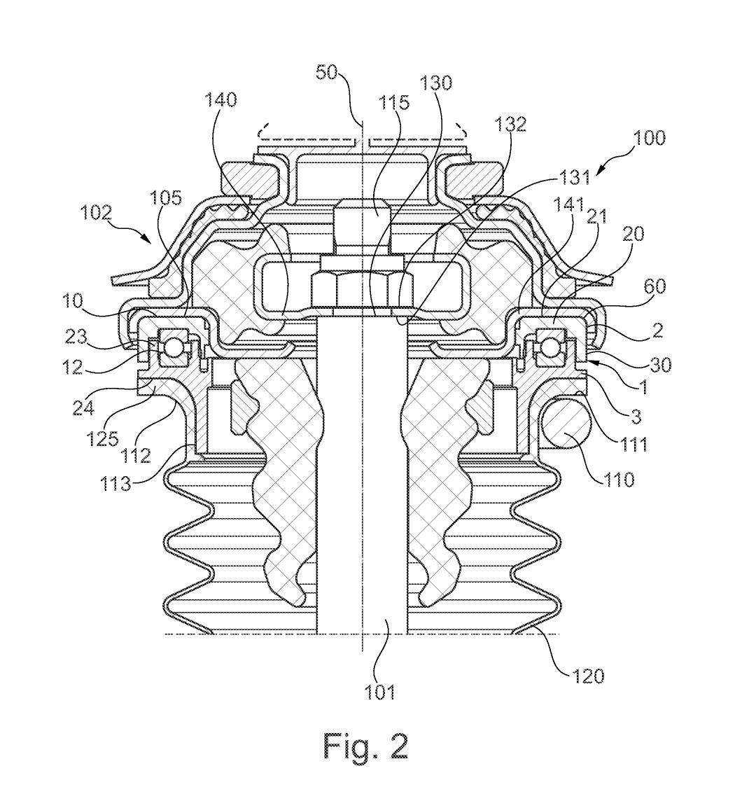

FIG. 2 is a cross sectional view of strut assembly 100 according to one example embodiment. Strut assembly 100 includes axis 50, shock absorber 101 with lower axial spring abutment surface (not shown) to support coil spring 110 on a axially lower radial surface (not shown) aligned with axis 50 and assembled substantially through dust cover 120, coil spring 110, strut bearing 1 and top mount 102. Upper spring abutment seat 125 has an axially lower radial surface 112 that abuts an upper radial surface 111 of coil spring 110, and strut bearing 1 is mounted or assembled on an axially upper radial surface 113. Strut bearing 1 can also be integrally formed with seat 125 or itself form a seat for coil spring 110. Strut bearing 1 includes upper housing 2 having an upper radial surface 20 and a lower radial surface 21, a through hole aligned with axis 50 for accommodating shock absorber 101 and lower housing 3 having upper radial surface 23 and lower radial surface 24 and a through hole aligned with axis 50. Strut bearing 1 can also include bearing 30 having races 34 and rolling elements 35. Bearing 30 may take any suitable form known in the art for a particular application.

Upper housing 2 further includes integrated seal 10 protruding axially above surface 20 and extending around the entire circumference of surface 20. In this embodiment seal 10 is shown as close to but not contacting axial end face 12 of upper housing 2, however, it will be understood by one skilled in the art that integrated seal 10 may be placed anywhere along a suitable portion radial surface 20. Integrated seal 10 is also shown in an uncompressed state for illustrative purposes in FIG. 2, however, when top mount 102 is assembled onto strut bearing 1 integrated seal will be at least partially compressed. In this embodiment, seal 10 is shown seated in continuous groove 60 of upper housing 2, however, groove 60 may also be non-continuous around the circumference radial surface 20. Seal 10 is fixedly integrated with upper housing 2 using, for example, an overmolding process or a two shot injection molding process.

Upper housing 2 is superimposed on lower housing 3, such that the through holes align with axis 50. Axially lower radial mounting surface 105 of portion 141 of top mount 102 is then mounted onto surface 20 of upper housing 2 of strut bearing 1 and axially lower radial surface 131 of portion 140 fixedly connected to portion 141 of top mount 102 is also mounted on axially upper radial mounting surface 130 of shock absorber 101. Fastener 115 is then used to fixedly secure top mount 102 to the assembly by fastening against surface 132 of portion 140 of top mount 102. As fastener 115 fixedly secures the assembly, portion 141 and surface 105 of top mount 102 compress integrated seal 10. This can prevent contamination ingress through the top mount to strut bearing interface and prevent ingress into the central areas of strut assembly 100.

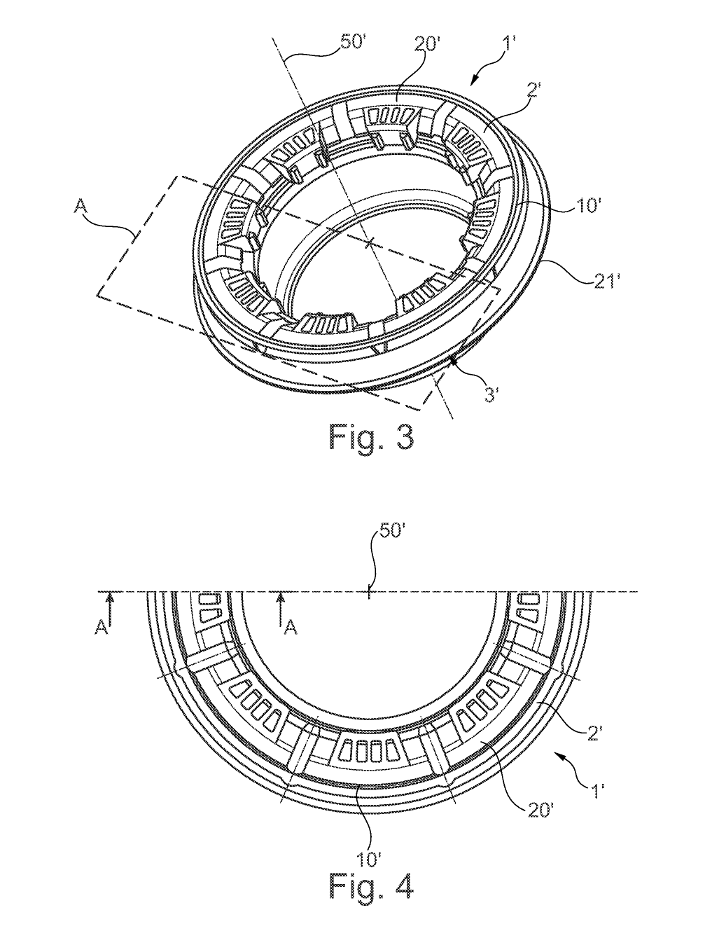

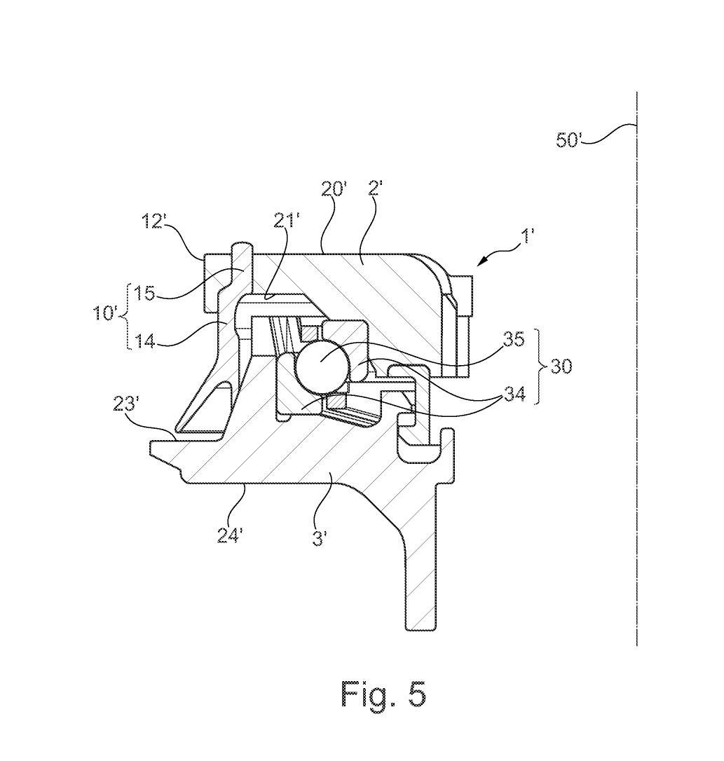

FIG. 3 is a perspective view of strut bearing 1′ according to a second example embodiment including axis 50′, upper housing 2′ having upper radial surface 20′, lower housing 3′ and integrated seal 10′. FIG. 4 is a top view of portion A of FIG. 3, showing upper radial surface 20′ of upper housing 2′ and integrated seal 10′. FIG. 5 is a cross sectional view of strut bearing 1′ of FIG. 4 taken along line A-A. The following description should be viewed in light of FIGS. 3 to 5. It will be understood by one skilled in the art that strut bearing 1′ of FIGS. 3 to 5 could be used in place of strut bearing 1 of FIG. 2 without substantially changing the surrounding components, therefore the surrounding structure related to strut assembly 100 will not be described in full.

Strut bearing 1′ can include bearing 30 having races 34 and rolling elements 35. Bearing 30 may take any suitable form known in the art for a particular application.

Upper housing 2′ further includes integrated seal 10′ having body portion 14 extending through upper housing 2′ and extending from lower radial surface 21′ of the upper housing 2′ toward upper radial surface 23′ of lower housing 3′ and axially upward protruding portion 15 extending from and integrally formed with integrated seal body 14 extending above upper radial surface 20′ of upper housing 2′ toward an associated top mount surface (for example, surface 105 of FIG. 2). Axially upward protruding portion 15 protrudes axially above surface 20′ and extends around the entire circumference of surface 20′. In this embodiment seal 10′ is shown as close to but not contacting axial end face 12′ of upper housing 2′. Portion 15 of integrated seal 10′ is also shown in an uncompressed state for illustrative purposes in FIG. 5, however, when top mount 102 (see FIG. 2) is assembled onto strut bearing 1′ portion 15 of integrated seal 1′ will be at least partially compressed. In this embodiment, axially upward protruding portion 15 is shown as semicircular in cross section, however, other suitable cross sections can be utilized, such as a rectangular cross section. Upper housing 2′ may be formed with seal 1′ using, for example, an overmolding process wherein upper housing 2′ is formed around seal 1′ or a two shot injection molding process wherein a two stage molding process is used to form seal 1′ and upper housing 2′ together.

Similar to the embodiment of FIG. 2, upper housing 2′ is superimposed on lower housing 3′, such that the through holes align with axis 50′. An associated surface of a top mount arranged to contact surface 20′ of upper housing 2′ is fixedly assembled onto surface 20′ and at least partially compresses axially upward protruding portion 15 of integrated seal 10′, sealing the strut bearing to top mount interface. This can prevent contamination ingress through the top mount strut bearing interface and prevent contamination entering the central areas of a strut assembly.

In the foregoing description, example embodiments are described. The specification and drawings are accordingly to be regarded in an illustrative rather than in a restrictive sense. It will, however, be evident that various modifications and changes may be made thereto, without departing from the broader spirit and scope of the present invention.

In addition, it should be understood that the figures illustrated in the attachments, which highlight the functionality and advantages of the example embodiments, are presented for example purposes only. The architecture or construction of example embodiments described herein is sufficiently flexible and configurable, such that it may be utilized (and navigated) in ways other than that shown in the accompanying figures.

Although example embodiments have been described herein, many additional modifications and variations would be apparent to those skilled in the art. It is therefore to be understood that this invention may be practiced otherwise than as specifically described. Thus, the present example embodiments should be considered in all respects as illustrative and not restrictive.

What we claim is:

1. A strut assembly comprising:
a top mount;
a shock absorber having an axial abutment surface;
a suspension strut bearing having a longitudinal axis in line with the shock absorber including:
an upper housing having an upper radial surface and lower radial surface, a through hole for accommodating the shock absorber and a fixedly integrated seal around an entire circumference of the upper housing;
a lower housing having an upper radial surface and a lower radial surface and a through hole for accommodating the shock absorber;
the upper housing superimposed on the lower housing such that the through holes align; and,
the integrated seal having an axially upward protruding portion extending from the upper housing and above the upper radial surface of the upper housing toward the top mount;
a coil spring arranged at least partially coaxially and surrounding the shock absorber and having a top and a bottom spring end, the bottom end supported on the shock absorber axial abutment surface and the top end supported at least partially on the lower radial surface of the lower housing; and,
the top mount assembled onto the upper radial surface of the upper housing, at least partially compressing the axially upward protruding portion of the integrated seal.

2. The strut assembly of claim 1, wherein the integrated seal includes a body extending through the upper housing and from the lower radial surface of the upper housing toward the upper radial surface of the lower housing.

3. The strut assembly of claim 2, wherein the integrated seal body is connected with the axially upward protruding portion.

4. The strut assembly of claim 1, wherein the axially upward protruding portion of the integrated seal is of a semi-circular cross section.

5. The strut assembly of claim 1, wherein the axially upward protruding portion of the integrated seal is of a rectangular cross section.

6. The strut assembly of claim 1, wherein the upper housing is overmolded onto the integrated seal.

7. The strut assembly of claim 1, wherein the upper housing and integrated seal are formed from a two shot injection molding process.

8. A strut bearing assembly comprising:
an upper housing having an upper and lower radial surface, a through hole arranged to accommodate a shock absorber and a fixedly integrated seal around an entire circumference of the upper housing;
a lower housing having an upper and a lower radial surface and a through hole arranged to accommodate a shock absorber;
the upper housing superimposed on the lower housing such that the through holes align;
the integrated seal having an axially upward protruding portion extending from the upper radial surface of the upper housing and arranged to be at least partially compressed by a top mount.

9. The strut bearing of claim 8, wherein the integrated seal includes a body extending through the upper housing and from the lower radial surface of the upper housing toward the upper radial surface of the lower housing.

10. The strut of claim 9, wherein the integrated seal body is connected with the axially upward protruding portion.

11. The strut of claim 8, wherein the axially upward protruding seal of the integrated seal is of a semi-circular cross section.

12. The strut of claim 8, wherein the axially upward protruding seal of the integrated seal is of a rectangular cross section.

13. The strut of claim 8, wherein the upper housing is overmolded onto the integrated seal.

14. The strut of claim 8, wherein the upper housing and integrated seal are formed from a two shot injection molding process.
